(19) United States
(12) Patent Application Publication
(10) Pub. No.: US 2006/0068228 A1
(43) Pub. Date: Mar. 30, 2006

(54) Laminated magnetic thin film and method of manufacturing the same

(76) Inventors: Kenji Ikeda, Gunma (JP); Kazuyoshi Kobayashi, Gunma (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/227,900

(22) Filed: Sep. 15, 2005

(30) Foreign Application Priority Data
Sep. 17, 2004 (JP) 2004-271303

(51) Int. Cl. G11B 5/66

(52) U.S. Cl. 428/828.1; 428/836.2; 427/127; 427/402

(57) ABSTRACT

A laminated magnetic thin film has a laminated structure in which insulating layers and granular layers are formed alternately on a substrate. The insulating layers are formed of SiO₂ films. The granular layers are formed of FeNiSiO films and have a structure in which an insulator is present in grain boundaries so as to wrap magnetic particles. It is possible to improve insulating properties of the insulating layers and the insulators and increase resistivity thereof by heating the substrate at the time of film formation. It is possible to control deterioration of a magnetic characteristic due to an increase in a resistivity and realize both a high magnetic characteristic and a high resistivity by changing thicknesses of the insulating layers and the magnetic layers and a ratio of the magnetic particles to the insulator to optimize a diameter of the magnetic particles having a composition within a predetermined range.

### BACKGROUND OF THE INVENTION

1. Field of the Invention

The present invention relates to a laminated magnetic film using a granular film including an insulator dotted with magnetic particles and a method of manufacturing the same. More specifically, the invention relates to realization of a high resistivity and control of deterioration in a soft magnetic characteristic in a high-frequency band.

2. Description of the Related Art

The development of the information communication technology facilitates a rapid increase in an amount of information communication and induces a demand for a high-performance information terminal. High communication speed and high convenience are intensely required of such an information terminal. There is also a strong demand for a reduction in sizes of electronic components and low power consumption. Under such a situation, the semiconductor technology in recent years have been coping with the reduction in sizes by applying different kinds of materials, which have not been used, to the electronic components. Application of magnetic materials is also starting to be examined. However, since the present communication apparatuses such as cellular phones and wireless LANs use a frequency in a gigahertz high-frequency band as an operating frequency, it is difficult to apply magnetic materials to these devices unless the magnetic materials operate in the gigahertz band.

In general, it is necessary to increase a resonance frequency in order to increase an operating frequency of a magnetic thin film. Since the resonance frequency is proportional to the square root of the product of saturation magnetization and an anisotropic magnetic field, materials with these values increased have been actively developed. Main magnetic substances presently used can be classified into a metal magnetic substance, an amorphous metal magnetic substance, an oxide magnetic substance, and the like. Among these magnetic substances, in the metal magnetic substance, an eddy current loss increases sharply when a frequency rises because the metal magnetic substance has a low resistivity. Thus, it is difficult to use the metal magnetic substance in a high-frequency band. The amorphous metal magnetic substance has a resistivity ten times or more as high as that of the metal magnetic substance. Thus, it is possible to use the amorphous metal magnetic substance at a high frequency to some extent. However, it is impossible to use the amorphous metal substance in the gigahertz band because the eddy current is large. The oxide magnetic substance such as ferrite has an extremely high resistivity. Thus, it is possible to substantially neglect the eddy current loss. However, since saturation magnetization is less than half compared with that of metallic magnetic substances, the oxide magnetic substance has an extremely low value of a magnetic permeability and is poor in serviceability.

As described above, there are many problems in using magnetic substances in a high-frequency band. However, in recent years, a magnetic thin film having a granular structure has been attracting attention as a magnetic substance for a high frequency, and research and developments for the magnetic thin film has been carried out (see, for example, JP-A-2002-299111). The granular structure is a structure in which magnetic particles with about a nanometer size (10⁻⁹ m) are embedded in a metal oxide serving as an insulator. A high soft magnetic characteristic due to refining of the magnetic particle and a high resistivity due to grain boundaries of an oxide are obtained. The granular structure magnetic thin film usually takes a high resistivity of 10⁻⁵ to 10⁻² Ωcm, which is about 100 to 1000 times as high as that of the metal magnetic substance. Thus, the influence of the eddy current loss is relatively small and a sufficient magnetic characteristic is obtained even at a high frequency such as a frequency in the gigahertz band.

However, although the value of a resistivity described above is high compared with that of the metal magnetic substance, the value is not high enough for the granular structure magnetic thin film to be regarded an insulator. Thus, when the granular structure magnetic thin film is used in an actual device, a parasitic capacitance component is caused between the granular structure magnetic thin film and other metal sections. Since this parasitic capacitance is very small, usually, almost no adverse effect is caused. However, in a high-frequency band as high as the gigahertz band, since impedance of the parasitic capacitance cannot be neglected, there is an inconvenience that a characteristic of the device is significantly deteriorated. In order to reduce the parasitic capacitance, a further increase in a resistivity is required. However, in the usual granular structure, when a ratio of an insulator is increased in order to raise the resistivity, exchange interaction among magnetic particles via conduction electrons falls. As a result, the magnetic particles lose ferromagnetism to come into a super-paramagnetic state. Therefore, there is a problem in that a magnetic characteristic is significantly deteriorated.

### SUMMARY OF THE INVENTION

The invention has been devised in view of the circumstances and it is an object of the invention to provide a laminated magnetic thin film, which uses a granular film and has a high resistivity and an excellent soft magnetic characteristic in a high-frequency band, and a method of manufacturing the same.

In order to attain the object, the invention provides a method of manufacturing a laminated magnetic thin film that uses a granular film including magnetic particles embedded in an insulator. In forming and stacking plural insulating layers and magnetic layers, which consist of the granular film, alternately on a substrate, the substrate is heated.

As one of main forms of the method of manufacturing a laminated magnetic thin film, the magnetic particles are made of a Fe—Ni alloy and the insulator and the insulating layers are made of SiO₂. As another form, a substrate temperature at the time of formation of the magnetic layers and the insulating layers is set to 150° C. or more and, preferably, 160° C. to 180° C.

As other forms, (1) an Ni composition in the magnetic particles is set to 20 to 40 atm %, (2) thickness of the insulating layer is set to 1.5 to 3.0 nm, (3) thickness of the magnetic layer is set to 3.5 to 7.0 nm, and (4) a ratio of a volume of the magnetic particles to the insulator in the magnetic layer is set to 1.3 to 1.7.

A laminated magnetic thin film of the invention is formed by any one of the methods of manufacturing described above.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

In the accompanying drawings:

FIG. 1A is a sectional view of a main part showing a laminated structure of a laminated magnetic thin film according to an embodiment of the invention;

FIG. 1B is a schematic diagram showing a structure of granular layer of the laminated magnetic thin film;

FIG. 2 is a graph showing a relation between a magnetic permeability and a resistivity and a substrate temperature at the time of film formation in the embodiment;

FIG. 3 is a graph showing a relation between saturation magnetism and a coercive force and a substrate temperature at the time of film formation in the embodiment;

FIG. 4 is a graph showing a relation between a magnetic permeability and a resistivity and an Ni composition in magnetic particles in the embodiment;

FIG. 5 is a graph showing a relation between saturation magnetization and a coercive force and an Ni composition in the magnetic particles;

FIG. 6 is a graph showing a relation between a magnetic permeability and a resistivity and thickness of insulating layer in the embodiment;

FIG. 7 is a graph showing a relation between saturation magnetization and a coercive force and thickness of the insulating layer in the embodiment;

FIG. 8 is a graph showing a relation between a magnetic permeability and a resistivity and thickness of the granular layer in the embodiment;

FIG. 9 is a graph showing a relation between saturation magnetization and a coercive force and thickness of the granular layer in the embodiment;

FIG. 10 is a graph showing a relation between a magnetic permeability and a resistivity and a ratio of magnetic metal particles to an insulator in the granular layer in the embodiment; and

FIG. 11 is a graph showing a relation between saturation magnetization and a coercive force and a ratio of the magnetic metal particles to the insulator in the granular layer.

### DESCRIPTION OF CERTAIN EMBODIMENTS

Certain embodiments will be hereinafter explained in detail with reference to the accompanying drawings.

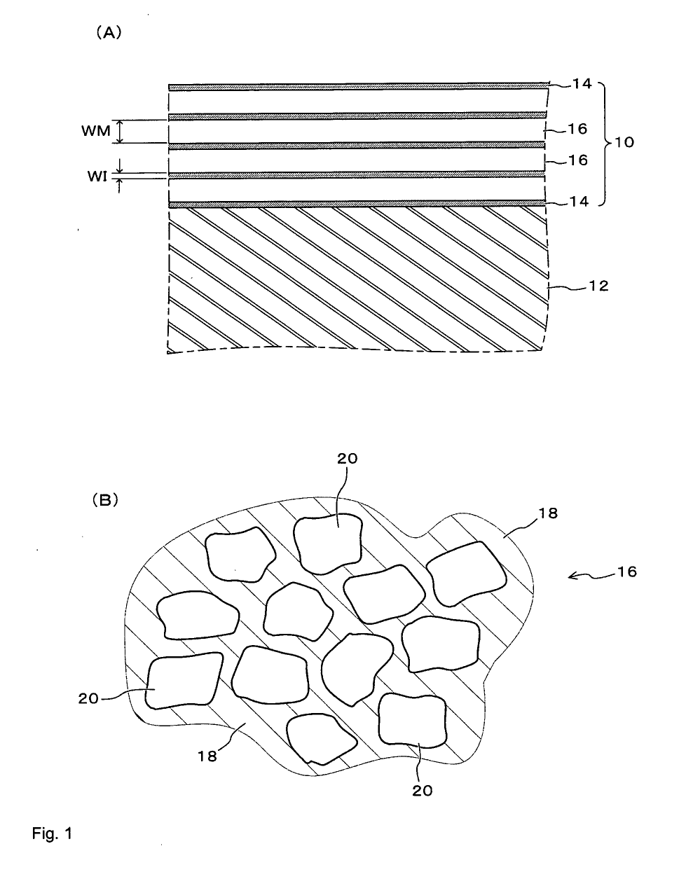

Embodiments of the invention will be explained with reference to FIGS. 1 to 11. FIG. 1A is a sectional view of a main part of a laminated magnetic thin film (or a laminated granular film) 10 according to an embodiment. FIG. 1(B) is a schematic diagram of a state of a granular magnetic layer 16 (hereinafter referred to as “granular layer”) observed from above. As shown in FIG. 1A, the laminated magnetic thin film 10 has a laminated structure in which plural insulating layers 14 and granular layers 16 are formed alternately on a substrate 12. As the substrate 12, for example, Si is used. The insulating films 14 are formed of, for example, SiO₂ films. The granular layers 16 are formed of, for example, FeNiSiO films consisting of an Fe—Ni alloy and SiO₂. As shown in FIG. 1B, the granular layer 16 consists of a granular thin film in which an insulator 18 and magnetic particles 20 such as metal coexist separately from each other. In other words, the insulator 18 is present in grain boundaries so as to wrap the magnetic particles 20. Note that, other than the Fe—Ni alloy, Ni, Fe, or the like may be used as the magnetic particles 20. However, it is possible to obtain a particularly high-quality film by using the Fe—Ni alloy.

As an example of a method of manufacturing the laminated magnetic thin film 10, using an inductive coupling RF sputtering apparatus, an FeNiSiO thin film (the granular layer 16) and an SiO₂ thin film (the insulating layer 14) having desired thicknesses on the order of about a nanometer are repeatedly formed on the substrate 12 to form the laminated magnetic thin film 10 under manufacturing conditions of (1) an atmospheric gas: Ar, (2) a film formation pressure: 420 mPa, (3) a back pressure: 1.0×10⁻⁵ Pa or less, (4) a film thickness: 500 nm, (5) targets: Fe, Ni, and SiO₂. In some embodiments, a range in which a resistivity and a magnetic characteristic of the laminated magnetic thin film 10 take values suitable for practical use is examined with the following variable parameters: substrate temperature at the time of formation of the laminated magnetic thin film 10, Ni composition in an FeNi alloy (the magnetic particles 20), thickness WI of the insulating layer 14, thickness WM of the granular layer 16, and ratio of the magnetic particles 20 to the insulator 18 in the granular layer 16.

Substrate Temperature

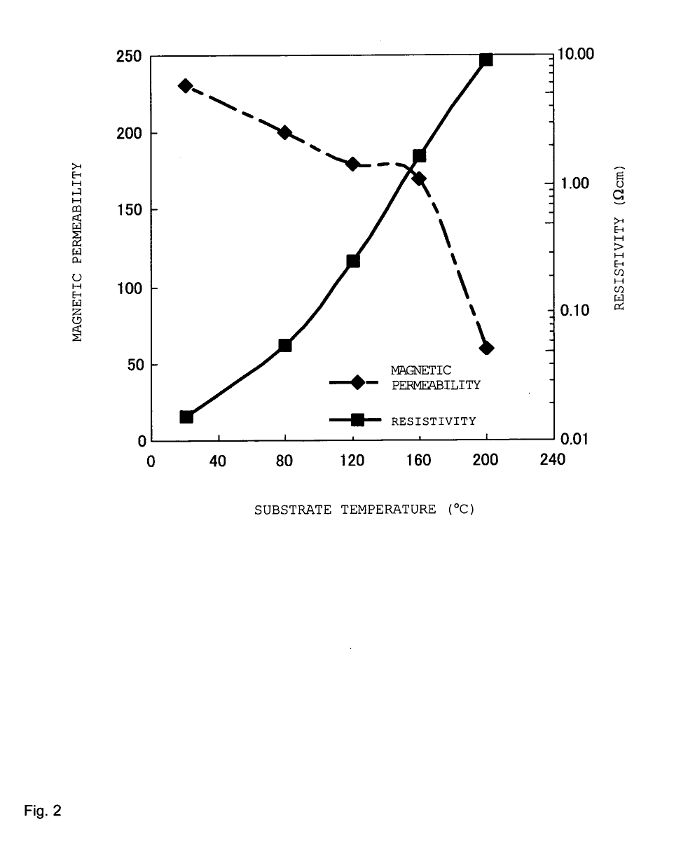

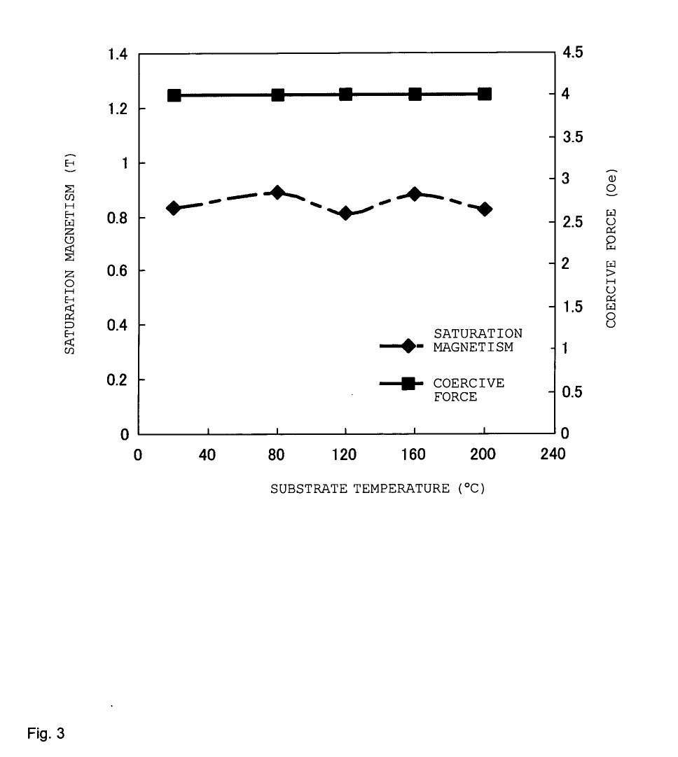

With reference to FIGS. 2 and 3, temperature of the substrate 12 at the time of film formation will be examined. FIG. 2 is a graph showing a relation between a magnetic permeability and a resistivity of the laminated magnetic thin film 10 in this embodiment at a frequency of 100 MHz (0.1 GHz) and a substrate temperature at the time of film formation. The abscissa represents the substrate temperature (° C.) and the ordinates represent the magnetic permeability and the resistivity (Ωcm), respectively. Note that a logarithmic scale is used on the ordinate representing the resistivity. FIG. 3 is a graph showing a relation between saturation magnetization and a coercive force of the laminated magnetic thin film and a substrate temperature at the time of film formation. The abscissa represents the substrate temperature (° C.) and the ordinates represent the saturation magnetization (T) and the coercive force (Oe), respectively. Note that temperature of the substrate 12 was changed between 20° C. and 200° C. As other conditions, an Ni composition in the alloy was fixed at 30 atm %, thickness of the granular layer 16 was fixed at 6 nm, thickness of the insulating layer 14 was fixed at 2 nm, and an FeNi/SiO₂ ratio in the granular layer 16 was fixed at 1.6. It is assumed that the substrate temperature is a measurement value of a thermocouple set on a stage on which a substrate of a sputtering apparatus is mounted (a display temperature of the sputtering apparatus).

As shown in FIG. 2, the resistivity increases exponentially according to a rise in the substrate temperature (a film formation temperature). On the other hand, the magnetic permeability decreases according to the rise in the substrate temperature. In particular, the magnetic permeability shows a sharp decrease at temperature from 160° C. to 200° C. On the contrary, as shown in FIG. 3, concerning the saturation magnetization and the coercive force, almost no change due to the film formation temperature is observed. Since the resistivity increases according to a rise in the substrate temperature, it is seen that it is effective to raise temperature of the substrate 12 at the time of film formation in order to manufacture the laminated magnetic thin film 10 with a high resistivity. Taking into account the fact that a magnetostatic characteristic such as the saturation magnetization/the coercive force changes little, it is considered that an improvement of the resistivity due to the rise in the substrate temperature is not caused by a change involving deterioration in a magnetic characteristic such as oxidation of the magnetic metal (the magnetic particles 20) but is caused mainly by an improvement of insulating properties of both the insulating layer 14 and the insulator 18. It is considered that an element changed to an in-plane isotropic magnetic film as a result of disappearance of uniaxial magnetic anisotropy significantly acts on the sharp decrease in the magnetic permeability at temperature from 160° C. to 200° C. Therefore, an excessively high substrate temperature prevents formation of the uniaxial magnetic anisotropy and, as a result, could cause deterioration in magnetic characteristics such as the magnetic permeability. Thus, it is seen that, in order to obtain the resistivity of 1 to 10 Ωcm and the magnetic permeability equal to or higher than 100, it is advisable to set the substrate temperature to 150° C. ore more and, preferably, in a range of 160 to 180° C.

Alloy Composition

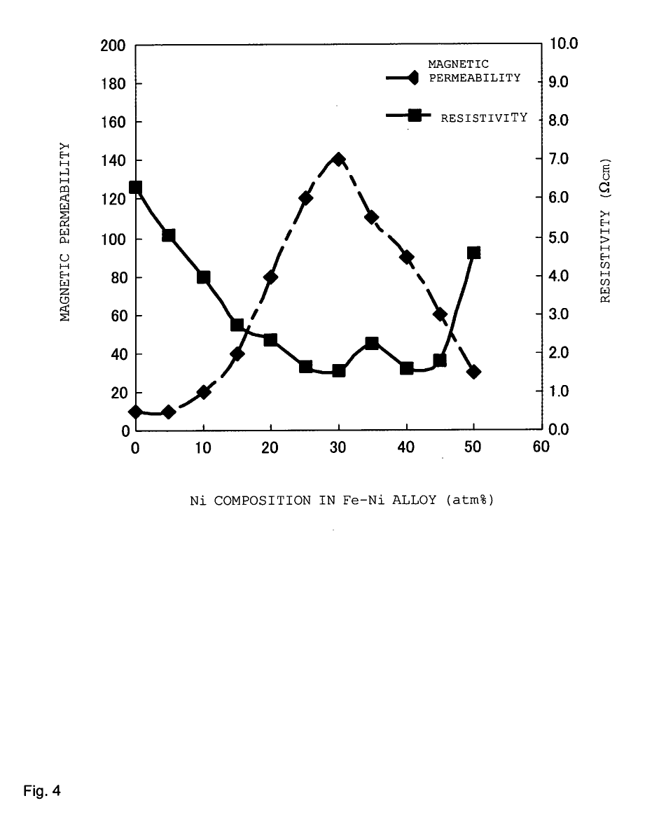

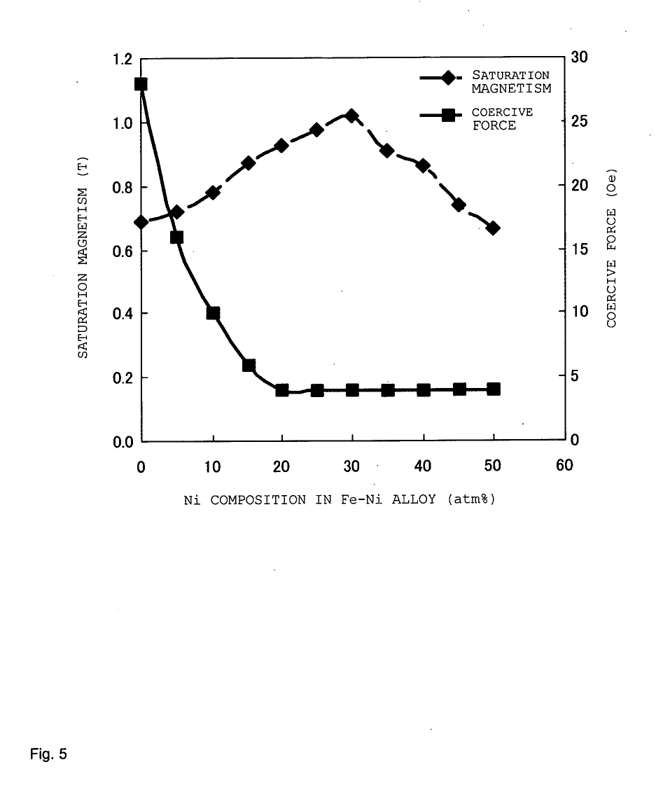

An Ni composition in an Fe—Ni alloy used as the magnetic particles 20 will be examined with reference to FIGS. 4 and 5. FIG. 4 is a graph showing a relation between a magnetic permeability and a resistivity of the laminated magnetic thin film 10 at a frequency of 100 MHz (0.1 GHz) and an Ni composition in magnetic particles 20. The abscissa represents the Ni composition (atm %) in an Fe—Ni alloy (the magnetic particles 20) and the ordinates represent the magnetic permeability and the resistivity (Ωcm), respectively. FIG. 5 is a graph showing a relation between saturation magnetization and a coercive force of the laminated magnetic thin film 10 and an Ni composition in the magnetic particles 20. The abscissa represents the Ni composition (atm %) in the Fe—Ni alloy and the ordinates represents the saturation magnetization (T) and the coercive force (Oe), respectively. Note that the Ni composition in the Fe—Ni alloy was changed between 0 and 50 atm %. As other conditions, temperature of a substrate 12 was fixed at 160° C., thickness of the granular layer 16 was fixed at 6 nm, thickness of an insulating layer 14 was fixed at 2 nm, and an FeNi/SiO₂ ratio in the granular layer 16 was fixed at 1.6. It is possible to control the Ni composition in the Fe—Ni alloy according to a ratio of electric energy applied to targets of Fe and Ni. A fluorescent X-ray was used for measurement of the Ni composition. The Ni composition was measured by irradiating an X-ray on a laminated magnetic thin film, measuring a peak intensity at a peak of Ni is measured from excited fluorescence, and comparing the peak intensity with a peak intensity measured with a standard sample having a specific Ni composition in advance.

As shown in FIG. 4, the resistivity takes a minimum value when the Ni composition is near 30 to 40 atm % and increases before and after that Ni composition. The resistivity always exceeds 1 Ωcm in when the Ni composition is between 0 and 50 atm %. Therefore, although a slight difference occurs, from the viewpoint of the resistivity, it is seen that it is possible to manufacture the laminated magnetic thin film 10 with a high resistivity in a wide range of the Ni composition of 0 to 50 atm %. Concerning the magnetic permeability, the magnetic permeability takes a maximum value when the Ni composition is 30 atm % and decreases sharply before and after that Ni composition. It is considered that this is caused by deterioration in soft magnetism due to an increase in a super-paramagnetic component in an area where the Ni composition is high and an increase in magnetocrystalline anisotropy in an area where the Ni composition is low. It is also possible to explain such a result of the magnetic permeability from a result of a magnetostatic characteristic shown in FIG. 5. An increase in the coercive force and a decrease in the saturation magnetization at the Ni composition equal to or lower than 20 atm % indicate an increase in the magnetocrystalline anisotropy. A decrease in the saturation magnetism at the Ni composition equal to or higher than 40 atm % indicates an increase in the super-paramagnetic component. On the other hand, it is considered that the Fe—Ni alloy with the Ni composition of 20 to 40 atm % has both the magnetocrystalline anisotropy of an appropriate magnitude and the saturation magnetism of a magnitude sufficient for preventing super-paramagnetism arrangement. From these results, when the magnetic permeability, the saturation magnetism, and the coercive force are taken into account, it is seen that an optimum composition of the Fe—Ni alloy in forming the laminated magnetic thin film 10 with a high resistivity (1 to 10 Ωcm) is in a range of Ni of about 20 to 40 atm % and, more preferably, in a range of 25 to 35 atm %.

Thickness of an Insulating Layer

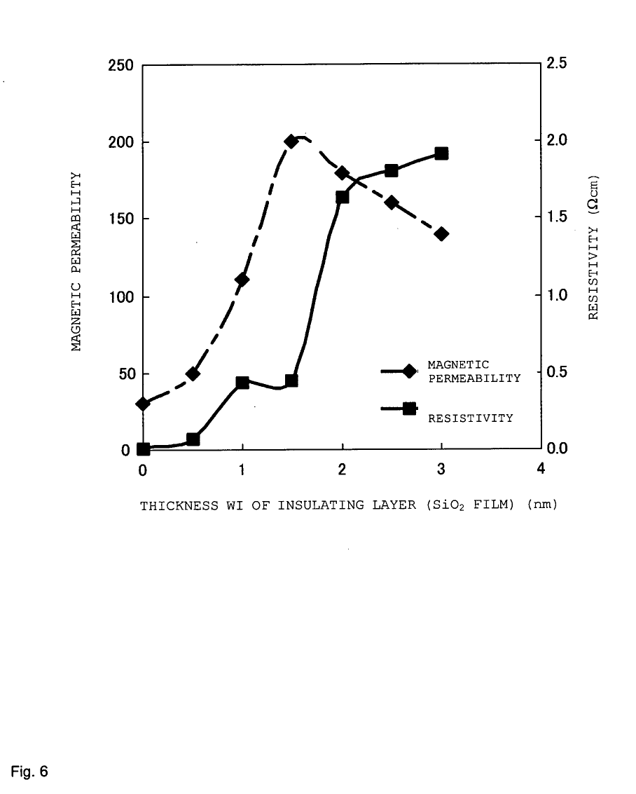

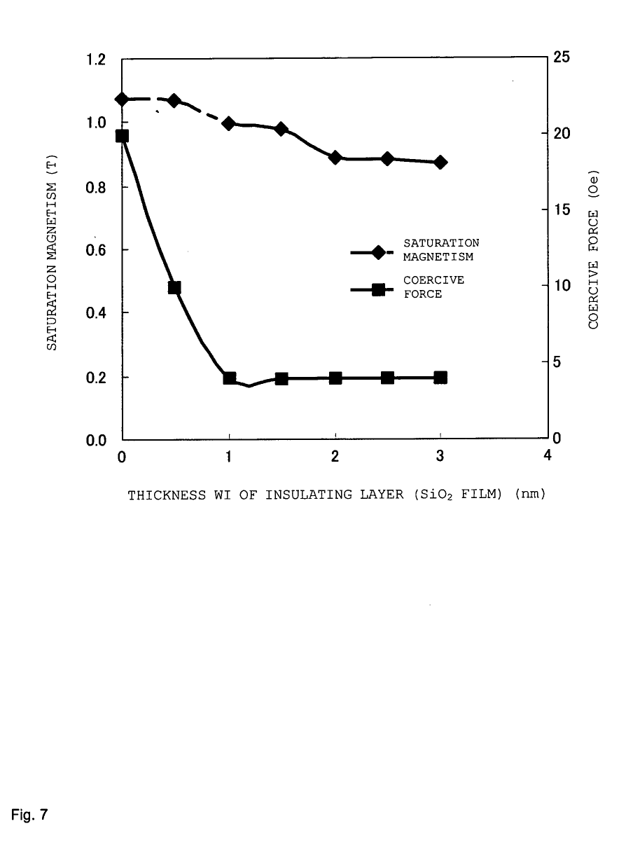

Thickness WI of the insulating layer 14 will be examined with reference to FIGS. 6 and 7. FIG. 6 is a graph showing a relation between a magnetic permeability and a resistivity of the laminated magnetic thin film 10 at a frequency of 100 MHz (0.1 GHz) and thickness of the insulating layer 14 (SiO₂ films). The abscissa represents thickness WI (nm) of the insulating layer 14 and the ordinates represent the magnetic permeability and the resistivity (Ωcm), respectively. FIG. 7 is a graph showing a relation between saturation magnetization and a coercive force of the laminated magnetic thin film 10 and thickness of the insulating layer 14. The abscissa represents thickness WI (nm) of the insulating layer 14 and the ordinates represent saturation magnetization (T) and a coercive force (Oe), respectively. Note that the thickness WI of the insulating layer 14 was changed between 0 and 3.0 nm. As other conditions, temperature of the substrate 12 at the time of film formation was fixed at 160° C., an Ni composition in the alloy was fixed at 30 atm %, thickness of the granular layer 16 was fixed at 6 nm, and an FeNi/SiO₂ ratio in the granular layer 16 was fixed at 1.6. Control for thickness of an insulating layer is performed by controlling an amount of film formation (a film formation rate) per time according to electric energy applied to targets and forming a film until time when a desired thickness is obtained. The film formation rate is measured in advance using a quartz resonator. Thickness of the insulating layer was measured from a sectional image taken by a TEM (Transmission Electron Microscope) using a scale provided in the TEM.

As shown in FIG. 6, the resistivity rises stepwise in three steps of 0 to 0.5 nm, 1.0 to 1.5 nm, and 2.0 to 3.0 nm as the thickness WI of the insulating layer 14 increases. The magnetic permeability takes a maximum value at 1.5 nm. It is considered that the resistivity changes stepwise because structures described below are formed in respective areas.

First, in an area where the thickness WI of the insulating layer 14 is 0 to 0.5 nm, the insulating layer 14 is not present. In other words, since the thickness WI is too small, a laminated structure cannot be formed. Therefore, a fine structure of the laminated magnetic thin film 10 is in a state in which the magnetic particles 20 are arranged three-dimensionally at random. There is almost no increase in the resistivity due to intervention of the insulating layer 14. Almost no increase in the magnetic permeability due to a particle diameter control/arrangement ratio of the magnetic particles 20 peculiar to the laminated structure occurs. With reference to FIG. 7 as well, in this area, although the saturation magnetization is high, the coercive force is also high. It is considered that this is caused by the random arrangement of the magnetic particles 20.

In an area where the thickness WI of the insulating layer 14 is 1.0 to 1.5 nm, a laminated structure is formed partially. There is an effect that particle growth of the magnetic particles 20 is controlled. In this structure, since the magnetic particles 20 are refined, the effect of the insulating layer 14 increases and the resistivity rises to some extent. Since the magnetic particles 20 can be manufactured uniformly, a value of the magnetic permeability increases significantly. With reference to FIG. 7 as well, since a ratio of the insulating layer 14 increases a little, although the saturation magnetization falls slightly, the coercive force is extremely reduced by the effect of the refining of the magnetic particles 20.

In an area where the thickness WI of the insulating layer 14 is 2.0 to 3.0 nm, in addition to the effect of control of particle growth of the magnetic particles 20, it is considered that the insulating layer 14 is formed clearly. In this structure, the resistivity is extremely high because of an synergistic effect of the fine magnetic particles 20 and the laminated insulating layer 14. On the other hand, as shown in FIG. 7, a value of the magnetic permeability tends to decrease a little because of the fall of the saturation magnetization due to a further increase in the ratio of the insulating layer 14. Judging from the result described above, from the viewpoint of the resistivity in the order of 1 Ωcm, it is considered that the thickness WI of the insulating layer 14 is suitably about 1.5 to 3.0 nm, at which the effect of lamination appears, and, more preferably, in a range of 2.0 to 2.5 nm.

Thickness of the Granular Layer

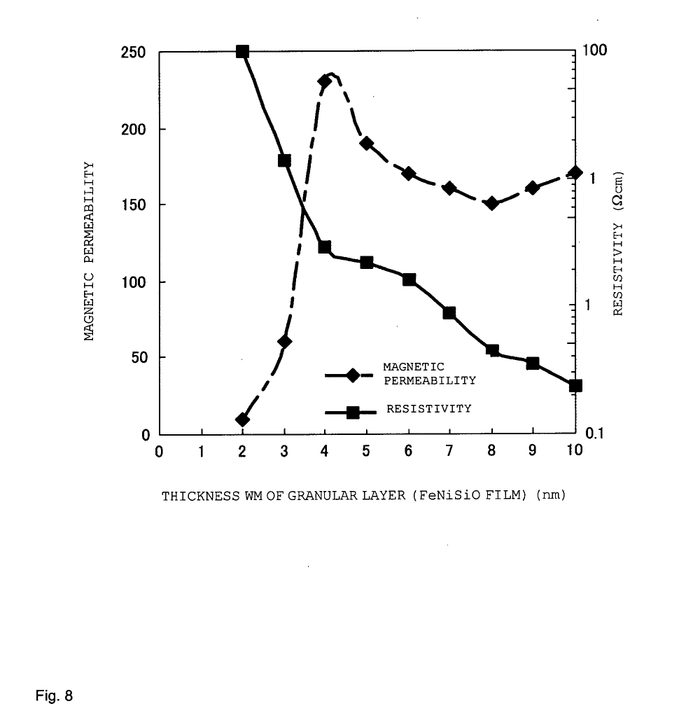

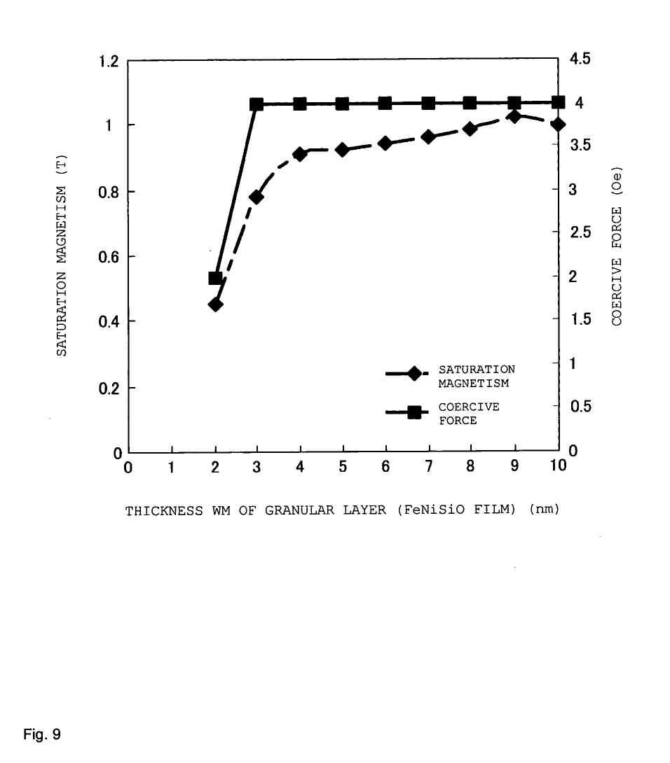

The thickness WM of the granular layer 16 will be examined with reference to FIGS. 8 and 9. FIG. 8 is a graph showing a relation between a magnetic permeability and a resistivity of the laminated magnetic thin film 10 at a frequency of 100 MHz (0.1 GHz) and thickness of the granular layer 16 (an FeNiSiO film). The abscissa represents the thickness WM (nm) of the granular layer 16 and the ordinates represent the magnetic permeability and the resistivity (Ωcm), respectively. Note that a logarithmic scale is used on the ordinate representing the resistivity. FIG. 9 is a graph showing a relation between saturation magnetization and a coercive force of the laminated magnetic thin film 10 and thickness of the granular layer 16. The abscissa represents the thickness WM (nm) of the granular layer 16 and the ordinates represent the saturation magnetization (T) and the coercive force (Oe), respectively. Note that the thickness WM of the granular layer 16 was changed between 2 and 10 nm. As other conditions, temperature of the substrate 12 at the time of film formation was fixed at 160° C., an Ni composition in the alloy was fixed at 30 atm %, thickness of the insulating layer 14 was fixed at 2 nm, and an FeNi/SiO₂ ratio in the granular layer 16 was fixed at 1.6. Control for thickness of a granular layer is performed by controlling an amount of film formation (a film formation rate) per time according to electric energy applied to targets and forming a film until time when a desired thickness is obtained. The film formation rate is measured in advance using a quartz resonator. Thickness of the granular layer was measure from a sectional image taken by a TEM using a scale provided in the TEM.

As shown in FIG. 8, the resistivity shows a tendency of decreasing monotonously as the thickness WM of the granular layer 16 increases. The magnetic permeability shows a maximum value near 4 nm. It is considered that the resistivity decreases because, since there is dependency of a particle diameter of the magnetic particles 20 in that, when the thickness WM of the granular layer 16 increases, the particle diameter increases in proportion to the thickness, as a result, a layer with a high electric conductivity becomes predominant. On the other hand, it is considered that a decrease in the magnetic permeability in an area where the thickness is equal to or smaller than 4 nm is caused by an increase in an influence of a super-paramagnetic state in which, since the magnetic particles 20 are refined excessively, magnetic moments are not equal because of thermal oscillation. Conversely, it is considered that a decrease in the magnetic permeability in an area where the thickness is equal to or larger than 4 nm is caused because, since a particle diameter of the magnetic particles 20 increases and a ratio of a surface area per unit volume decreases, exchange interaction among adjacent particles falls.

Concerning a characteristic of the saturation magnetization, FIG. 9 indicates that the saturation magnetization falls sharply, the laminated magnetic thin film 10 loses ferromagnetism, and the super-paramagnetism changes in an area where the thickness WM of the granular layer 16 is equal to or smaller than 3 nm. The coercive force also decreases as the thickness WM of the granular layer 16 decreases to 3 nm or less. However, this is caused by the loss of the ferromagnetism and does not indicate an improvement of the soft magnetic characteristic. When this result is taken into account, it is considered that it is suitable to set the thickness WM of the granular layer 16 to about 3.5 to 7.0 nm and, more preferably, in a range of 4.0 to 6.0 nm.

A Ratio of Magnetic Metal in a Granular Layer

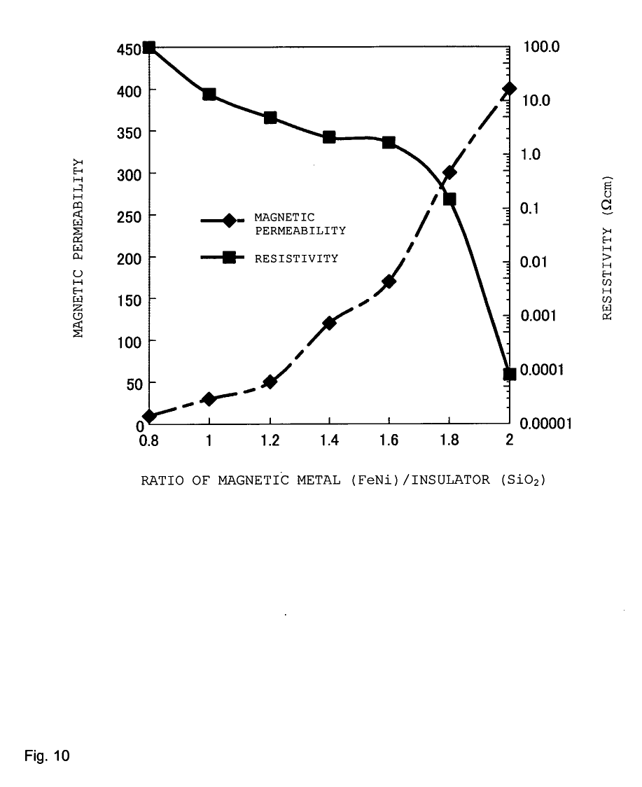

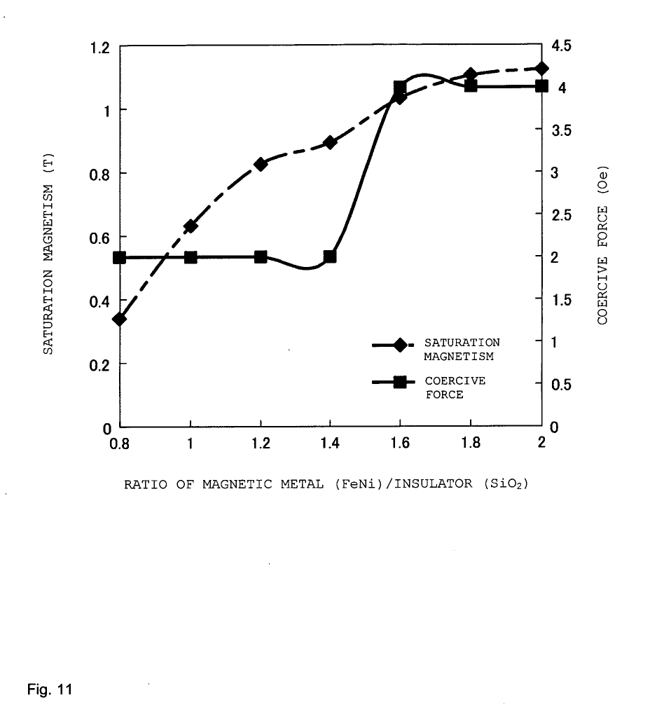

A ratio of the magnetic particles (the magnetic metal) 20 to the insulator 18 in the granular layer 16, that is, FeNi/SiO₂ will be examined with reference to FIGS. 10 and 11. FIG. 10 is a graph showing a relation between a magnetic permeability and a resistivity of the laminated magnetic thin film 10 at a frequency of 100 MHz (0.1 GHz) and an FeNi/SiO₂ ratio in the granular layer 16. The abscissa represents the FeNi/SiO₂ ratio and the ordinates represent the magnetic permeability and the resistivity (Ωcm), respectively. Note that a logarithmic scale is used on the ordinate representing the resistivity. FIG. 11 is a graph showing a relation between saturation magnetization and coercive force of the laminated magnetic thin film 10 and the FeNi/SiO₂ ratio in the granular layer 16. The abscissa represents the FeNi/SiO₂ ratio and the ordinates represent the saturation magnetization (T) and the coercive force (Oe), respectively. Note that the FeNi/SiO₂ ratio was changed between 0.8 and 2.0. As other conditions, temperature of the substrate 12 at the time of film formation was fixed at 160° C., an Ni composition in the alloy was fixed at 30 atm %, thickness of the insulating layer 14 was fixed at 2 nm, and thickness of the granular layer 16 was fixed at 6 nm. Control for a ratio of magnetic particles to an insulator in a granular layer is performed by controlling a ratio of respective film formation rates. The film formation rates are controlled by a value calculated by multiplying electric energy applied to targets by respective coefficients. The ratio of magnetic particles to an insulator in a granular layer was measured by a TEM and an EDS. The measurement is performed as described below. An electron beam is irradiated on a granular layer portion in a TEM image of a section of a laminated magnetic thin film and a composition ratio is calculated from a peak intensity of an obtained peak according to calculation in the EDS apparatus. This measurement is performed for arbitrary ten sections to calculate an average composition ratio. A volume ratio is calculated from this average composition ratio and usual densities and atomic weights (molecular weights) of Fe, Ni, and SiO₂.

As shown in FIG. 10, the resistivity decreases as the ratio of the magnetic particles 20 (Fe—Ni) to the insulator 18 (SiO₂) increases. In particular, the resistivity decreases sharply in an area where the ratio is equal to or higher than 1.8. Conversely, the magnetic permeability shows a sharp increase as the ratio rises. The ratio of the insulator 18 and the magnetic particles 20 in the granular layer 16 mainly affects thickness of the insulator 18 in an in-plane direction of the thin film. In other words, since a percentage of the magnetic particles 20 decreases as the ratio decreases, the thickness of the insulator 18 increases and the resistivity rises. Since a percentage of the magnetic particles 20 increases as the ratio rises, the thickness of the insulator 18 decreases and the resistivity falls. In particular, when the thickness of the insulator 18 decreases and the magnetic particles 20 adjacent to one another are substantially bonded metallically, it is predicted that the resistivity becomes extremely small. It is considered that a sharp decrease in the resistivity in an area where the ratio changes from 1.8 to 2.0 is caused by such a change of a bonding state among the magnetic particles 20.

Therefore, considering a value of the resistivity, it is desirable to set the ratio of the magnetic particles 20 to the insulator 18 as small as possible. However, when the ratio is set excessively small, the magnetic particles 20 have super-paramagnetism and the magnetic permeability decreases. Therefore, when a balance between the resistivity and the magnetic permeability is taken into account, it is suitable to set the FeNi/SiO₂ ratio (a ratio of volumes) in a range of 1.3 to 1.7 and, more preferably, in a range of 1.4 to 1.6. Note that, as shown in FIG. 11, the saturation magnetization increases as the ratio increases. It is considered that this is caused by an increase in the percentage of the magnetic particles 20 and the coercive force changes because of an influence of a super-paramagnetic component.

As described above, according to the embodiment, there are advantages as described below.

(1) In the laminated structure in which the granular layer 16, which includes the fine magnetic particles 20 of about a nanometer size embedded in the insulator 18, and the insulating layer 14 are stacked in a nanometer order, a substrate is heated when a film is formed. Thus, it is possible to improve insulating properties of both the insulating layer 14 and the insulator 18 and raise resistivity thereof. This makes it possible to decrease a loss at the time when the laminated magnetic thin film 10 is used for a device.

(2) It is possible to control deterioration in a magnetic characteristic due to a rise in a resistivity and realize both a high magnetic characteristic and a high resistivity by changing thicknesses of the insulating layer 14 and the granular magnetic layer 16 and the ratio of the magnetic particles 20 to the insulator 18 to optimize a diameter of the magnetic particles 20 having a composition within a predetermined range.

Note that the invention is not limited to the embodiments described above, and it is possible to modify the invention in various ways within a range not departing from the spirit of the invention. For example, the invention may be modified as described below.

(1) In one embodiment, an Fe—Ni alloy is used as the magnetic particles 20. However, various kinds of magnetic metal may be used. For example, it is possible to use Co, Fe, Ni, and the like. In addition, in the embodiment, SiO₂ is used as the insulating layer 14 and the insulator 18. However, other insulators such as Al₂O₃ and MgO may be used. The substrate 12 is only an example and various other substrates may be used.

(2) The numbers of laminated layers of the insulating layer 14 and the granular layer 16 are only examples. It is possible to increase or decrease the numbers appropriately and obtain the same advantages.

(3) The conditions of film formation described in the embodiment are only examples. The conditions may be changed appropriately as required within a range in which the film thicknesses and the substrate temperatures described above are satisfied.

(4) The laminated magnetic thin film 10 of the invention is applicable to various magnetic components and devices used in a high-frequency band such as a thin film inductor and a thin film transformer. Moreover, the magnetic components and the devices may be applied to various apparatuses such as a cellular phone.

According to some embodiments, in a laminated structure in which magnetic layers of a granular structure, which includes fine magnetic particles of a nanometer size embedded in an insulator, and insulating layers are stacked in a nanometer order, it is possible to improve insulating properties of both the insulating layers and the insulator by heating the substrate at the time of film formation, and raise resistivity thereof. It is possible to control deterioration in a magnetic characteristic due to an increase in a resistivity and realize both a high magnetic characteristic and a high resistivity by changing thicknesses of the insulating layers and the magnetic layers and a ratio of the magnetic particles to the insulator to optimize a diameter of particles of magnetic metal having a composition within a predetermined range.

What is claimed is:

1. A method of manufacturing a magnetic thin film, the method comprising:
forming a granular film comprising magnetic particles embedded in a first insulator; and
alternately stacking layers of the granular film and a second insulator on a substrate while heating the substrate.

2. The method of claim 1, wherein the magnetic particles comprise an Fe—Ni alloy, and the first and second insulators comprise SiO₂.

3. The method of claim 1, wherein heating the substrate comprises heating the substrate to a temperature equal to or higher than about 150° C. at the time of alternately stacking the layers.

4. The method of claim 3, wherein the temperature is between about 160° C. and about 180° C.

5. The method of claim 2, wherein the Fe—Ni alloy has an NI composition of between about 20 atm %. and about 40 atm %.

6. The method of claim 1, wherein a thickness of the second insulator is between about 1.5 nm and about 3.0 nm.

7. The method of claim 1, wherein the granular film has a thickness between about 3.5 nm and 7.0 nm.

8. The method of claim 1, wherein the granular film has a ratio of volume of magnetic particles to volume of first insulator between about 1.3 and about 1.7.

9. A laminated magnetic thin film manufactured by the method of claim 1.

10. An electronic device comprising a laminated magnetic thin film manufactured by the method of claim 1.

11. A laminated magnetic film comprising a granular film including magnetic particles encompassed by an insulator, wherein plural insulating layers and magnetic layers consisting of the granular film are formed and alternately stacked on a heated substrate.

12. The thin film of claim 11, wherein the magnetic particles comprise an Fe—Ni alloy, and the first and second insulators comprise SiO₂.

13. The thin film of claim 12, wherein the Fe—Ni alloy has an Ni composition of between about 20 atm % and about 40 atm %.

14. The thin film of claim 11, wherein a thickness of the second insulator is between about 1.5 nm and about 3.0 mm.

15. The thin film of claim 11, wherein the granular film has a thickness between about 3.5 nm and 7.0 nm.

16. The thin film of claim 11, wherein the granular film has a ratio of volume of magnetic particles to volume of first insulator between about 1.3 and about 1.7.

17. An electronic device comprising a laminated magnetic thin film comprising:
a plurality of insulating layers; and
a plurality of magnetic layers, wherein the magnetic layers each comprise a granular film comprising magnetic particles embedded in an insulator and the insulating layers and the magnetic layers have been alternately stacked on a heated substrate.

18. The device of claim 17, wherein the magnetic particles comprise an Fe—Ni alloy, and the first and second insulators comprise SiO₂.

19. The device of claim 18, wherein the Fe—Ni alloy has an Ni composition of between about 20 atm %. and about 40 atm %.

20. The method of claim 19, wherein a thickness of the second insulator is between about 1.5 nm and about 3.0 nm.

21. The method of claim 17, wherein the granular film has a thickness between about 3.5 nm and 7.0 nm.

22. The method of claim 17, wherein the granular film has a ratio of volume of magnetic particles to volume of first insulator between about 1.3 and about 1.7.
